(19) United States
(12) Patent Application Publication
(10) Pub. No.: US 2024/0326974 A1
(43) Pub. Date: Oct. 3, 2024

(54) OUTBOARD MOTOR OIL GUIDE MEMBER AND OUTBOARD MOTOR

(71) Applicant: HONDA MOTOR CO., LTD., Tokyo (JP)

(72) Inventor: Norikazu Kawai, Wako-shi (JP)

(21) Appl. No.: 18/128,369

(22) Filed: Mar. 30, 2023

(51) Int. Cl. B63H 21/38; H02K 5/173; H02K 7/08; H02K 7/116; H02K 9/19

(52) U.S. Cl. CPC B63H 21/386; H02K 5/1732; H02K 7/083; H02K 7/116; H02K 9/19

(57) ABSTRACT

An oil guide member is used for an outboard motor capable of switching a disposition between a first disposition that is a disposition of the outboard motor at the time of navigation of a marine vessel and a second disposition in which a rear side is lifted further upward than the first disposition. The oil guide member guides oil for lubrication to a lubricated portion. The oil guide member includes a discharge hole and an oil accumulation part. The discharge hole is arranged at a position that enables dropping of the oil to the lubricated portion in a state of the first disposition. The oil accumulation part enables accumulation of the oil in a state of the second disposition and is capable of draining the accumulated oil to the discharge hole in the state of the first disposition.

### BACKGROUND OF THE INVENTION

### Field of the Invention

The present invention relates to an oil guide member of an outboard motor and an outboard motor.

### Background Art

In a propulsion apparatus of a marine vessel, a screw submerged in outside water is driven by a drive mechanism. The drive mechanism includes a drive source such as an internal combustion engine or an electric motor, a speed reduction mechanism that reduces the rotation of the drive source, and the like.

Further, as a propulsion apparatus of a marine vessel, an apparatus is known that further includes a steering mechanism that performs steering by changing the direction of a screw shaft (for example, refer to Patent Document 1).

The propulsion apparatus described in Patent Document 1 includes a pivot cylinder that is rotatable about an axis along a vertical direction, and a screw shaft is supported by the rotation cylinder. The pivot cylinder is connected to an electric motor for steering driving via a speed reduction mechanism. The pivot cylinder is pivoted by the driving of the electric motor for steering driving and thereby changes the direction of the screw shaft. Further, the screw shaft and a screw connected to the screw shaft are driven by another electric motor for driving different from the electric motor for steering driving.

Further, in a propulsion apparatus described in Patent Document 1 (Japanese Unexamined Patent Application, First Publication No. 2022-144364), a plurality of apparatuses such as a speed reducer accommodated in a case are lubricated by oil for lubrication. The oil for lubrication is supplied to each portion in the case by an oil pump and performs both cooling and lubrication of the plurality of apparatuses.

### SUMMARY OF THE INVENTION

In this type of propulsion apparatus, the oil flows down from a lubricated portion of the apparatus when the navigation of the marine vessel is stopped for a long time, and lubrication insufficiency easily occurs at the time of operation restart of the apparatus. In particular, in a tilt-type outboard motor that switches the disposition to a disposition in which a rear side is lifted upward at the time of navigation stop of the marine vessel or the like, when the disposition in which the rear side is lifted upward continues for a long time, the oil easily flows down from the lubricated portion of the apparatus.

Accordingly, the present invention is intended to provide an oil guide member of an outboard motor and an outboard motor capable of promptly supplying oil to a lubricated portion of an apparatus even after the navigation of a marine vessel is stopped for a long time.

An outboard motor oil guide member according to an aspect of the present invention is used for an outboard motor capable of switching a disposition between a first disposition that is a disposition of the outboard motor at the time of navigation of a marine vessel and a second disposition in which a rear side is lifted further upward than the first disposition and guides oil for lubrication to a lubricated portion, the outboard motor oil guide member including: a discharge hole that is arranged at a position that enables dropping of the oil to the lubricated portion in a state of the first disposition; and an oil accumulation part that enables accumulation of the oil in a state of the second disposition and is capable of draining the accumulated oil to the discharge hole in the state of the first disposition.

In the oil guide member of the configuration described above, when performing the navigation of the marine vessel in the state of the first disposition of the outboard motor, the oil introduced above the discharge hole is dropped through the discharge hole to the lubricated portion. Thereby, the lubricated portion is lubricated by the dropped oil.

Further, when the outboard motor is switched from the state of the first disposition to the state of the second disposition at the time of stopping of the marine vessel or the like, the oil is accumulated in the oil accumulation part. Then, when the outboard motor is switched from the state of the second disposition to the state of the first disposition when navigation of the marine vessel is restarted or the like, the oil accumulated in the oil accumulation part flows out to the discharge hole. As a result, the oil drops through the discharge hole to the lubricated portion. Thereby, the lubricated portion is promptly lubricated by the dropped oil.

The oil accumulation part may include: a bottom wall portion that is arranged at a further forward side than the discharge hole: a front wall portion that stands upward from a front end section of the bottom wall portion; and a pair of side wall portions that close right and left sides of the front wall portion and the bottom wall portion.

In this case, when the outboard motor is switched from the state of the first disposition to the state of the second disposition, the oil becomes accumulated in a region surrounded by the bottom wall portion, the front wall portion, and the pair of side wall portions. In this case, it becomes possible to easily adjust the amount of accumulated oil in the state of the second disposition by a change in protrusion heights of the pair of side wall portions and the front wall portion.

A regulation wall that regulates the flow of the oil that flows rearward beyond the discharge hole may be provided on a rear section of the bottom wall portion.

In this case, when the outboard motor is switched from the state of the second disposition to the state of the first disposition, the oil flows rearward from the region surrounded by the bottom wall portion, the front wall portion, and the pair of side wall portions. At this time, the flow to the rearward side of the oil beyond the discharge hole is regulated by the regulation wall. As a result, the accumulated oil can be efficiently dropped from the discharge hole.

At least part of the regulation wall may be formed in a V shape in plan view that is inclined rearward from both right and left sides toward a rear portion of the discharge hole.

In this case, when the outboard motor is switched from the state of the second disposition to the state of the first disposition, the oil that flows rearward from the region surrounded by the bottom wall portion, the front wall portion, and the pair of side wall portions is guided to a V shape portion in plan view of the regulation wall. As a result, the oil is efficiently collected toward the discharge hole and is dropped from the discharge hole to the lubricated portion.

An oil preparation chamber may be further provided that is capable of storing the oil in the state of the first disposition and is capable of draining the stored oil to the oil accumulation part in the state of the second disposition.

In this case, the oil is stored in the oil preparation chamber when the outboard motor is in the state of the first disposition. Then, when the outboard motor is switched from the state of the first disposition to the state of the second disposition, the oil stored in the oil preparation chamber flows into the oil accumulation part.

In the case of the present configuration, when the outboard motor is stopped for a long time while maintaining the state of the first disposition and is then switched to the state of the second disposition, the stored oil of the oil preparation chamber can be reliably accumulated in the oil accumulation part at the time of switching.

An inclination passage in which a portion close to the oil accumulation part is at a higher position than a portion close to the oil preparation chamber in the state of the first disposition and that allows the oil to flow out from the oil preparation chamber to the oil accumulation part in the state of the second disposition may be arranged between the oil preparation chamber and the oil accumulation part.

In this case, when the outboard motor is in the state of the first disposition, since the portion of the inclination passage close to the oil accumulation part becomes higher than the portion of the inclination passage close to the oil preparation chamber, the oil is reliably stored in the oil preparation chamber without completely flowing out from the oil preparation chamber. Therefore, even when the outboard motor is stopped for a long time while maintaining the state of the first disposition, it is possible to prevent the oil preparation chamber from becoming empty. Further, when the outboard motor becomes the state of the second disposition from the state of the first disposition, the oil in the oil preparation chamber flows into the oil accumulation part through the inclination passage. Then, when the outboard motor is switched from the state of the second disposition to the state of the first disposition, the oil in the oil accumulation part drops through the discharge hole to the lubricated portion.

At least part of the oil preparation chamber may be arranged below an electric motor for driving a screw at a drop position of the oil that has cooled the electric motor.

In this case, the oil can be reliably stored in the oil preparation chamber without providing a dedicated passage for introducing the oil to the oil preparation chamber.

A support portion of a bearing that supports a rotation shaft of the electric motor may be further provided, the oil preparation chamber may be formed of a groove having a U shape in plan view that is arranged outside the support portion of the bearing such that each of a pair of end portions of the groove having the U shape faces forward, and the oil accumulation part may be arranged between a pair of end regions of the groove having the U shape.

In this case, since the oil preparation chamber is provided so as to surround the support portion of the bearing, the electric motor and the oil guide member can be arranged to be sufficiently close to each other. The oil that has cooled the electric motor is stored in the groove having a U shape in plan view of the oil preparation chamber. In this state, when the outboard motor is switched from the state of the first disposition to the state of the second disposition, the oil flows forward while being divided to right and left sides along the groove having the U shape in plan view and flows into the oil accumulation part arranged between the end regions of the groove having the U shape. At this time, the oil smoothly flows forward along the groove having the U shape. Further, since the oil is divided to two directions and flows into the oil accumulation part from the oil preparation chamber, overflow of the oil does not easily occur when flowing into the oil accumulation part. Accordingly, when the present configuration is employed, the oil can be efficiently supplied to the lubricated portion without waste at the time of switching of the outboard motor from the state of the first disposition to the state of the second disposition.

An outboard motor according to an aspect of the present invention is capable of switching a disposition between a first disposition that is a disposition at the time of navigation of a marine vessel and a second disposition in which a rear side is lifted further upward than the first disposition, the outboard motor including: an apparatus that requires lubrication at the time of operation; and an oil guide member that guides oil for lubrication to a lubricated portion of the apparatus, wherein the oil guide member includes: a discharge hole that is arranged at a position that enables dropping of the oil to the lubricated portion in a state of the first disposition; and an oil accumulation part that enables accumulation of the oil in a state of the second disposition and is capable of draining the accumulated oil to the discharge hole in the state of the first disposition.

The outboard motor may further include: a drive source for driving a screw; and a pump device that operates by receiving power of the drive source and supplies oil to an upper portion of the oil guide member, wherein the apparatus that requires lubrication at the time of operation may include an electric motor for steering driving and a power transmission device that transmits power of the electric motor to a steering portion, and the lubricated portion may be an engagement portion by a gear between the power transmission device and the electric motor.

In the case of the outboard motor of the present configuration, in a situation where the drive source for driving the screw stops and the pump device does not operate, oil cannot be supplied to the engagement portion by the pump device. However, when the outboard motor in the state of the second disposition is switched to the state of the first disposition, the oil accumulated in the oil accumulation part of the oil guide member drops through the discharge portion to the engagement portion. Thereby, the engagement portion is promptly lubricated by the oil.

Accordingly, when the present configuration is employed, even when the steering portion is steered by the electric motor in the situation where the drive source is stopped, lubrication failure does not occur at the engagement portion by the gear.

### Effects of the Invention

According to the present invention, it is possible to promptly supply oil to the lubricated portion of the apparatus even after the navigation of the marine vessel is stopped for a long time.

### BRIEF DESCRIPTION OF THE DRAWINGS

FIG. 1 is a side view of a marine vessel of an embodiment.

FIG. 2 is a partial cross-sectional side view of an outboard motor of the embodiment.

FIG. 3 is an enlarged partial cross-sectional side view of part of the outboard motor shown in FIG. 2.

FIG. 4 is a side view when the outboard motor of the embodiment is in a state (tilt-up state) of a second disposition.

FIG. 5 is a perspective view of an assembly body of a support block and an oil guide member of the embodiment.

FIG. 6 is a plan view of the assembly body of the support block and the oil guide member of the embodiment.

FIG. 7 is a cross-sectional view along a VII-VII line of FIG. 6.

FIG. 8 is a cross-sectional view along a VIII-VIII line of FIG. 6.

FIG. 9 is a cross-sectional view along a IX-IX line of FIG. 6.

FIG. 10 is a cross-sectional view of part of the outboard motor of the embodiment showing the flow of oil at the time of normal operation.

FIG. 11 is a cross-sectional view of part of the outboard motor of the embodiment showing the state of the oil when the outboard motor is switched from a first disposition to a second disposition.

FIG. 12 is a cross-sectional view of part of the outboard motor of the embodiment showing the state of the oil when the outboard motor is switched from the second disposition to the first disposition.

### EMBODIMENTS

Hereinafter, embodiments of the present invention will be described with reference to the drawings.

In appropriate positions of the drawings, an arrow FR that indicates a forward side of a propulsion direction of an outboard motor 11, an arrow UP that indicates a vertically upward direction, and an LH that indicates a leftward direction when facing a forward direction of the outboard motor 11 are shown.

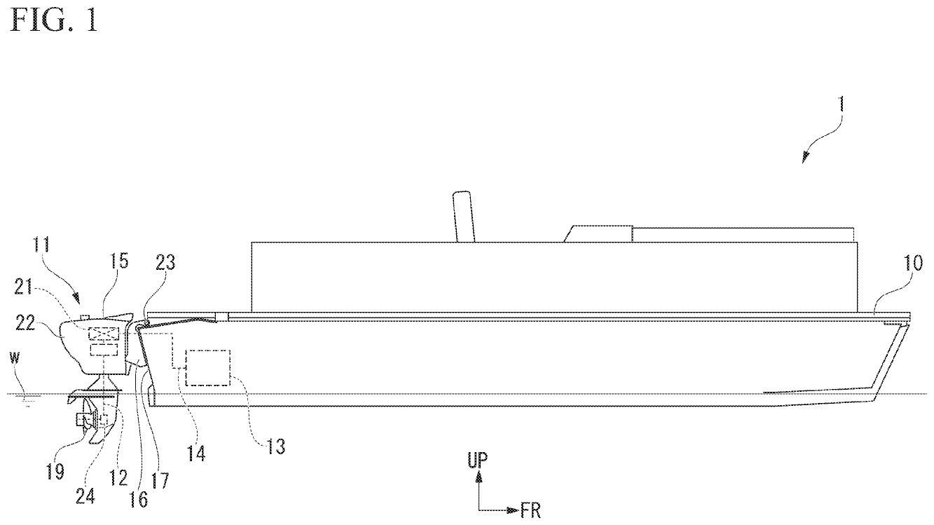

FIG. 1 is a side view of a marine vessel 1 of an embodiment that is propelled forward when seen from a rightward direction.

The marine vessel 1 includes a hull 10 and the outboard motor 11 provided on a rear portion of the hull 10. A battery 13 is provided on the hull 10. A DC cable 14 for supplying electric power of the battery 13 to the outboard motor 11 is wired between the battery 13 and the outboard motor 11. The battery 13 can be provided on the outboard motor 11.

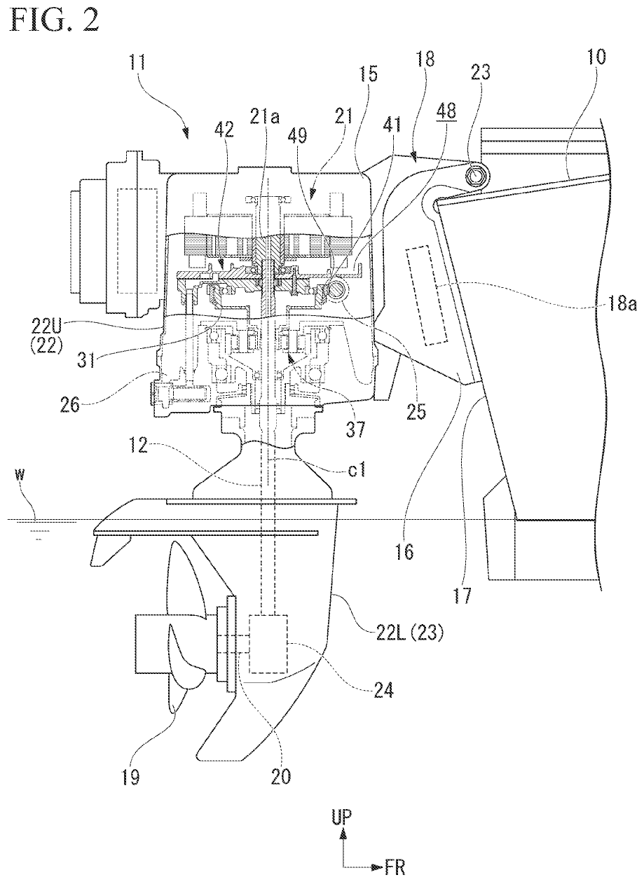

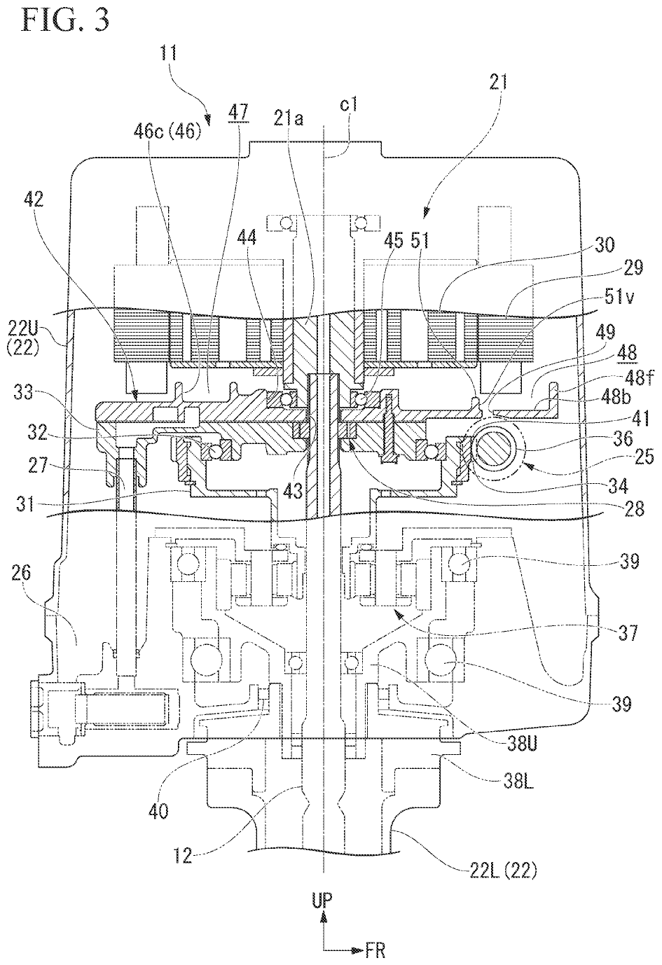

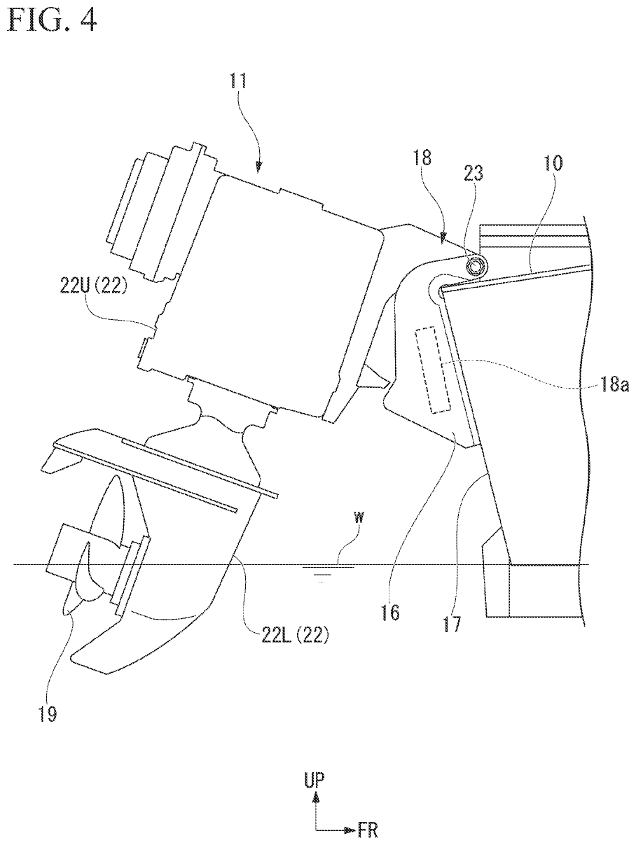

FIG. 2 is a side view of the outboard motor 11 when seen from a rightward direction, and FIG. 3 is an enlarged view of part of FIG. 2. Further, FIG. 4 is a side view when the outboard motor 11 is in a state (tilt-up state) of a second disposition.

The outboard motor 11 includes an outboard motor main body 15 and an attachment portion 16 for attaching the outboard motor main body 15 to the hull 10. The attachment portion 16 is fixed to a transom 17 at a rear portion of the hull 10. A tilt device 18 is provided on the attachment portion 16. The tilt device 18 is a device that appropriately switches between a first disposition (a disposition shown in FIG. 2) that is a disposition at the time of navigation of the marine vessel 1 and a second disposition (a disposition shown in FIG. 4) in which a rear portion of the outboard motor 11 (outboard motor main body 15) is lifted further upward than the first disposition by an operation of an actuator 18a. In the state of the first disposition, a shaft (screw shaft 20) of a screw 19 described later becomes substantially horizontal in outside water w (water such as seawater or river water). In the state of the second disposition, the rear portion of the outboard motor 11 (outboard motor main body 15) is lifted upward (tilted up), and a front end side of the shaft (screw shaft 20) of the screw 19 is inclined upward.

In the state of the first disposition, a drive shaft 12 described later faces vertically downward, and in the state (tilt-up state) of the second disposition, a lower end side of the drive shaft 12 is inclined rearward and downward.

The outboard motor 11 includes: a screw 19 that is submerged in outside water w and generates a propulsion force; an electric motor 21 (a drive source for driving a screw) that drives and rotates the screw 19; and an outboard motor case 22 that accommodates a variety of apparatuses such as a lubrication cooling mechanism or a drive-related component including the electric motor 21 in the inside of the outboard motor case 22. The outboard motor case 22 is supported by a skeleton member (not shown). The skeleton member is supported rotatably in an upward-downward direction by the rear portion of the hull 10 about a tilt shaft 23.

The tilt shaft 23 is a shaft of the tilt device 18 that is supported by the hull 10 and extends along a rightward-leftward direction (an upward-downward direction and a direction perpendicular to the forward-rearward direction) of the outboard motor 11.

With respect to the outboard motor 11, at the first disposition in which the screw 19 is submerged in the outside water w, a side that faces vertically upward is referred to as “upward”, and a side that faces vertically downward is referred to as “downward”. Further, in particular, unless otherwise stated, a side (side at which the tilt shaft 23 is present) attached to the hull 10 of the outboard motor 11 is referred to as “forward”, and the opposite side of the “forward” side is referred to as “rearward”.

The outboard motor case 22 includes an upper case 22U that accommodates the lubrication cooling mechanism and the drive-related component including the electric motor 21 or the like, and a lower pivot case 22L that accommodates a power transmission mechanism 24. The drive shaft 12 is coaxially connected to a rotation shaft 21a of the electric motor 21. The power transmission mechanism 24 is a speed reduction mechanism constituted of a bevel gear or the like, reduces the rotation of the drive shaft 12 to a predetermined deceleration ratio, and transmits the rotation to the screw shaft 20. The upper case 22U is attached to the rear portion of the hull 10 via the tilt device 18. The lower pivot case 22L is connected (supported) rotatably to a lower portion of the upper case 22U. The lower pivot case 22L is rotatable around a rotation center axis line cl of the drive shaft 12.

The screw 19 is rotatably supported integrally by the screw shaft 20 that penetrates substantially horizontally through a circumference wall of the lower pivot case 22L. The screw shaft 20 is rotatably supported by the lower pivot case 22L and is connected to the power transmission mechanism 24 at the inside of the lower pivot case 22L. The screw 19 receives rotation power of the electric motor 21 and generates propulsion by rotating in the outside water w. At the time of navigation of the marine vessel 1, the lower pivot case 22L is submerged in the outside water w together with the screw 19.

The lower pivot case 22L is operated and rotated in a predetermined angle range by an electric motor 25 for steering driving that is arranged at the inside of the upper case 22U. The screw 19 supported by the lower pivot case 22L pivots together with the lower pivot case 22L around the rotation center axis line c. The outboard motor 11 can change the propulsion direction by changing the direction of the screw 19 by the electric motor 25 for steering driving.

As shown in FIG. 3, an oil reservoir 26 for that stores oil for cooling and lubrication and a pump device 28 for suctioning the oil in the oil reservoir 26 and causing the oil to flow to a circulation flow passage 27 are arranged within the upper case 22U. The oil can be supplied to a mechanical component in the upper case 22U and thereby lubricate the mechanical component. The pump device 28 is driven by the power of the electric motor 21.

The pump device 28 may employ devices of various types such as a trochoid type, a centrifugal type, or a gear type that can supply the oil suctioned from the oil reservoir 26 to the circulation flow passage 27.

The circulation flow passage 27 supplies the oil suctioned from the oil reservoir 26 by the pump device 28 to a cooler (not shown) and cools the oil. The cooler is supported, for example, by a stay (not shown) that extends forward and downward from a front portion of the upper case 22 and is submerged in the outside water w in that state. The cooler submerged in the outside water w cools the oil supplied from the pump device 28 by heat exchanging with the outside water w. Then, the circulation flow passage 27 causes the oil cooled at the lower pivot case 22L side to return to the upper case 22U side again and discharges the oil to a heat generation portion such as a stator 29 or a rotor 30 of the electric motor 21. Thereby, the heat generation portion of the electric motor 21 is cooled by the oil. At this time, the oil discharged to the heat generation portion of the electric motor 21 is dropped downward and returns to the oil reservoir 26. The oil that returns to the oil reservoir 26 is supplied to the circulation flow passage 27 again by the pump device 28.

A power transmission cylinder 31 having a substantially cylindrical shape is arranged coaxially with the rotation center axis line cl of the drive shaft 12 within the upper case 22U. The drive shaft 12 is inserted through a center portion of the power transmission cylinder 31. The power transmission cylinder 31 is formed in a cylindrical shape having a step. That is, an upper region of the power transmission cylinder 31 is formed in a cylindrical shape having a large diameter, and a lower region is formed in a cylindrical shape having a smaller diameter than that of the upper region. The upper cylindrical portion having a large diameter of the power transmission cylinder 31 is rotatably supported by a support block 33 in the upper case 22U through a bearing 32. The support block 33 is fixed to a frame member (not shown) in the upper case 22U. An outer tooth 34 that functions as a worm wheel is attached to an outer circumference of the cylindrical portion having a large diameter of the power transmission cylinder 31. A worm 36 engages with the outer tooth 34. The worm 36 is driven by the electric motor 25 for steering driving.

The cylindrical portion having a small diameter on the lower side of the power transmission cylinder 31 is connected to output cylinders 38U, 38L via a planetary gear speed reducer 37. The upper output cylinder 38U side is rotatably supported by the upper case 22U via a bearing 39. The lower output cylinder 38L is connected to an upper end portion of the lower pivot case 22L. The lower output cylinder 38L protrudes downward from a lower surface of the upper case 22U. A space between the lower output cylinder 38L and the upper case 22U is sealed by a seal member 40.

The electric motor 25 for steering driving is connected to the power transmission cylinder 31 via an engagement portion 41 (engagement portion by a gear) between the worm 36 and the outer tooth 34, and the power transmission cylinder 31 is connected to the lower pivot case 22L via the speed reducer 37 and the output cylinder 38U, 38L. Accordingly, the rotation of the electric motor 25 is decelerated by the power transmission cylinder 31 (the engagement portion 41 between the worm 36 and the outer tooth 34) and the speed reducer 37 and is transmitted to the lower pivot case 22L.

In the present embodiment, the power transmission cylinder 31 and the speed reducer 37 constitute a power transmission device. Further, the electric motor 25 for steering driving and the power transmission device described above constitute an apparatus that requires lubrication at the time of operation.

An oil guide member 42 for guiding the oil for cooling and lubrication to the engagement portion 41 (lubricated portion) between the worm 36 and the outer tooth 34 is fixedly provided on an upper portion of the support block 33 in the upper case 22U. The oil guide member 42 is constituted of a block having a plate shape, and part of the oil guide member 42 extends above the engagement portion 41 (lubricated portion) between the worm 36 and the outer tooth 34.

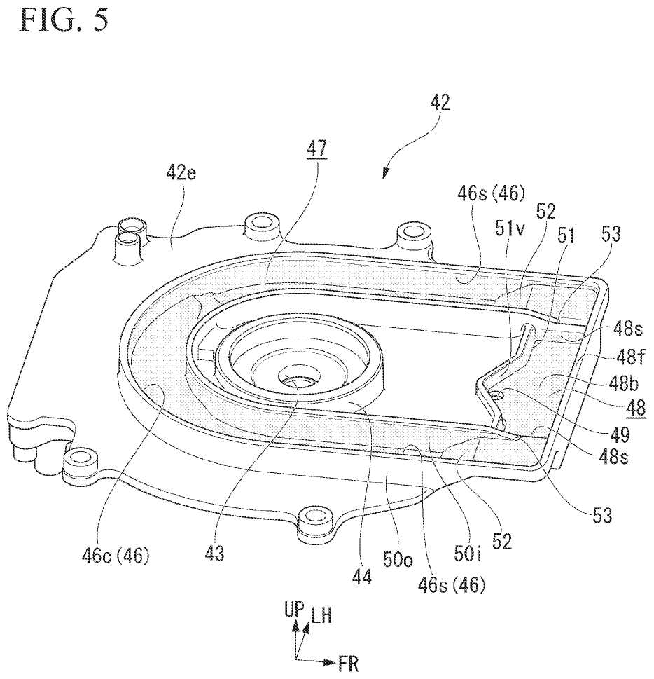

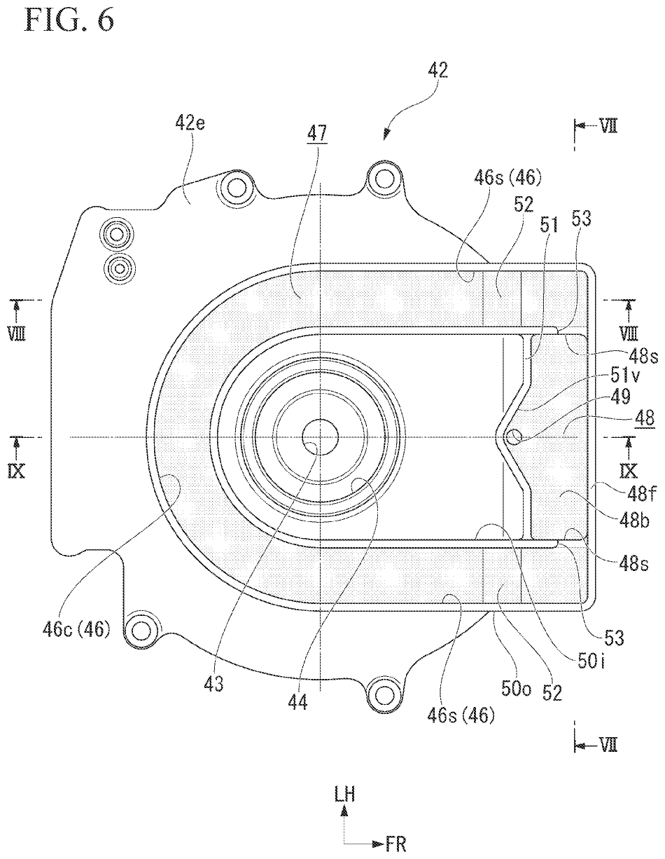

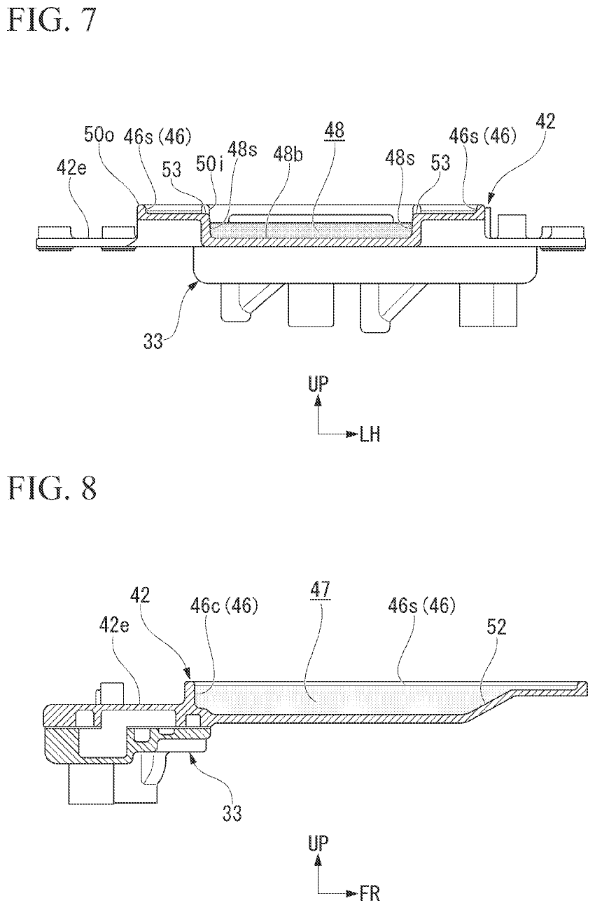

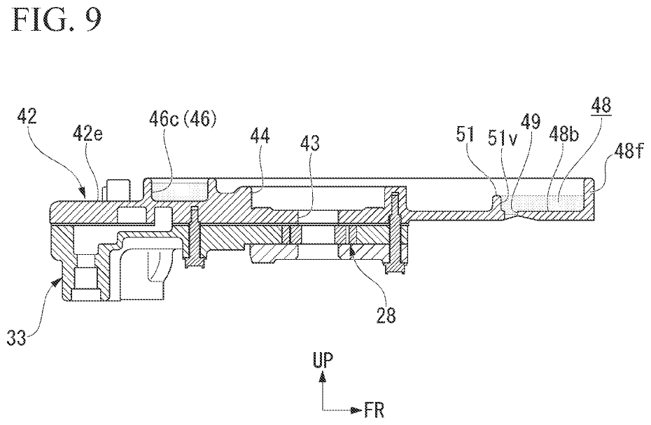

FIG. 5 is a perspective view of an assembly body of the support block 33 and the oil guide member 42, and FIG. 6 is a plan view of the assembly body of the support block 33 and the oil guide member 42. FIG. 7 is a cross-sectional view along a VII-VII line of FIG. 6, and FIG. 8 is a cross-sectional view along a VIII-VIII line of FIG. 6. Further, FIG. 9 is a cross-sectional view along a IX-IX line of FIG. 6. In FIG. 5 to FIG. 9, for ease of understanding, dots are attached to a portion where the oil flows on the oil guide member 42.

The oil guide member 42 is overlapped on an upper surface of the support block 33 and is fastened and fixed to the support block 33 in that state. The oil guide member 42 is formed in a substantially circular shape in plan view having a distorted outer circumference portion. A shaft insertion hole 43 through which the drive shaft 12 (refer to FIG. 3) penetrates in the upward-downward direction is formed substantially at the middle in plan view of the oil guide member 42. The pump device 28 held by the support block 33 is arranged substantially at the middle portion at a lower surface side of the oil guide member 42. A rotation drive portion of the pump device 28 is connected to the drive shaft 12 below the shaft insertion hole 43.

An annular circumferential wall 44 having a circular ring shape that is a bearing support portion is provided to protrude in a circumferential region of the shaft insertion hole 43 on the upper surface side of the oil guide member 42. The annular circumferential wall 44 supports a bearing 45 (refer to FIG. 3) by an inner circumferential portion of the annular circumferential wall 44. The bearing 45 rotatably supports the rotation shaft 21a of the electric motor 21.

A groove 46 having a substantially U shape in plan view is formed outside the annular circumferential wall 44 on the upper surface of the oil guide member 42. The groove 46 opens upward and constitutes an oil preparation chamber 47 described later. The groove 46 is constituted of an inner wall 50i and an outer wall 50o that are raised upward relative to an outer edge portion 42e of the oil guide member 42. A pair of straight sections 46s of the groove 46 having a substantially U shape in plan view extends along a forward-rearward direction, and a curved section 46c that connects the pair of straight sections 46s to each other is arranged at the rear side of the shaft insertion hole 43. The curved section 46c is formed so as to surround the outside of a substantially half region of the rear side of the annular circumferential wall 44. Each end portion on the opposite side of the curved section 46c of the pair of straight sections 46s faces forward.

Part of the pair of straight sections 46s and the curved section 46c are arranged below the electric motor 21 at a drop position of the oil that has cooled the electric motor 21. Accordingly, the pump device 28 operates in response to the power of the electric motor 21 that is a drive source and supplies the oil to an upper portion of the oil guide member 42.

An oil accumulation part 48 that opens upward is formed between front end regions of the pair of straight sections 46s of the groove 46 described above. The oil accumulation part 48 includes: a bottom wall portion 48b having an upper surface that becomes substantially horizontal when the outboard motor 11 is in the state of the first disposition: a front wall portion 48f that stands upward from a front end section of the bottom wall portion 48b; and a pair of side wall portions 48s that close right and left sides of the front wall portion 48f and the bottom wall portion 48b. A discharge hole 49 that penetrates through the bottom wall portion 48b in the upward-downward direction is formed at a front end position and a middle in the rightward-leftward direction of the bottom wall portion 48b. The bottom wall portion 48b is arranged at a further forward position than the discharge hole 49. The discharge hole 49 is arranged at a position where the oil can be dropped to the engagement portion 41 (lubricated portion) between the worm 36 and the outer tooth 34 in the state where the outboard motor 11 is in the first disposition.

The oil accumulation part 48 can accumulate the oil when the outboard motor 11 is in the state of the second disposition and can drain the accumulated oil to the discharge hole 49 when the outboard motor 11 is in the state of the first disposition.

Further, a regulation wall 51 that regulates the flow of oil that flows rearward beyond the discharge hole 49 is provided to protrude on a rear section of the bottom wall portion 48b. Right and left end portions of the regulation wall 51 are connected to the right and left inner walls 50i that form the groove 46. The protrusion height of the regulation wall 51 is lower than the protrusion heights of the right and left side wall portions 48s and the front wall portion 48f.

The inner region in the rightward-leftward direction of the regulation wall 51 is formed in a V shape in plan view that is inclined rearward from both right and left sides toward the rear portion of the discharge hole 49. Hereinafter, the V shape portion in plan view of the regulation wall 51 is referred to as a “V-shaped guide portion 51v”. Since the V-shaped guide portion 51v is provided on the regulation wall 51, when the oil accumulated in the oil accumulation part 48 flows rearward, the oil is guided by the V-shaped guide portion 51v and is collected to the discharge hole 49.

In the present embodiment, a V-shaped guide portion 51v is provided in the inner region in the rightward-leftward direction of the regulation wall 51; however, the entire regulation wall 51 may be formed in a V shape in plan view that is inclined rearward from both right and left sides toward the rear portion of the discharge hole 49.

Further, an inclination passage 52 in which a portion close to the oil accumulation part 48 is higher than a portion close to the oil preparation chamber 47 when the outboard motor 11 is in the state of the first disposition is provided on the groove 46 that forms the oil preparation chamber 47 in an end region on the forward side of each of the right and left straight sections 46s. The oil accumulation part 48 communicates with the highest region of each of the right and left inclination passages 52 via a hollow groove 53 having a notch shape. The hollow groove 53 is formed on the inner wall 50i in a rear region of each of the right and left straight sections 46s. A bottom portion of the hollow groove 53 is higher than an upper surface of the bottom wall portion 48b of the oil accumulation part 48.

The inclination passage 52 that is provided on each of the right and left straight sections 46s allows the oil to flow out from the oil preparation chamber 47 to the oil accumulation part 48 when the outboard motor 11 is in the state of the second disposition. Each inclination passage 52 is formed, for example, such that the bottom surface of the inclination passage 52 becomes substantially horizontal or such that the inclination passage 52 becomes an inclination state where the rear side is higher than the front side when the outboard motor 11 is in the state of the second disposition.

Next, the flow of the oil at the time of normal operation of the marine vessel 1, the flow of the oil when switching the outboard motor 11 from the state of the first disposition to the state of the second disposition (tilt-up state), and the flow of the oil when switching the outboard motor 11 from the state of the second disposition to the state of the first disposition are described.

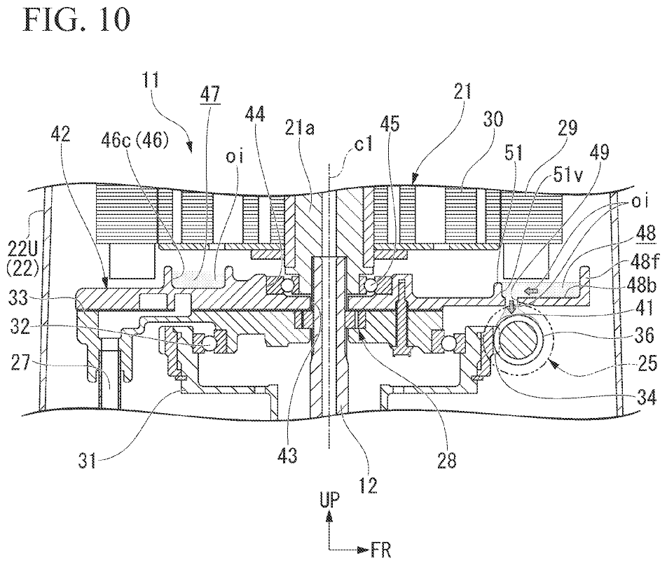

FIG. 10 is a cross-sectional view of part of the outboard motor 11 showing the flow of oil oi at the time of normal operation.

At the time of normal operation, the outboard motor 11 is in the state of the first disposition as shown in FIG. 10. In this state, by the driving of the electric motor 21 for driving a screw, the pump device 28 operates, and by the operation of the pump device 28, the oil oi flows in the circulation flow passage. At this time, the oil oi pumped upward above the electric motor 21 is discharged to the stator 29 and the rotor 30 of the electric motor 21. In this way, the oil oi discharged to the stator 29 and the rotor 30 cools the stator 29 and the rotor 30 and then flows downward. The oil oi that has flowed downward in this way drops onto the oil guide member 42, sequentially passes through the oil preparation chamber 47 and the oil accumulation part 48 on the oil guide member 42, and flows downward from the discharge hole 49. The oil oi that has flowed downward from the discharge hole 49 drops onto the engagement portion 41 between the worm 36 and the outer tooth 34, lubricates the engagement portion 41, and then flows further downward. The oil oi that has flowed further downward lubricates the lubricated portion of another apparatus and then returns to the oil reservoir.

When the marine vessel stops (the electric motor 21 for driving the screw of the outboard motor 11 stops) in the state where the outboard motor 11 is in the first disposition, the oil oi in the oil accumulation part 48 on the oil guide member 42 flows downward through the discharge hole 49. Then, when all of the oil oi in the oil accumulation part 48 flows downward, the flow of the oil oi on the oil guide member 42 stops. As a result, the oil oi is stored substantially only in the oil preparation chamber 47 on the oil guide member 42.

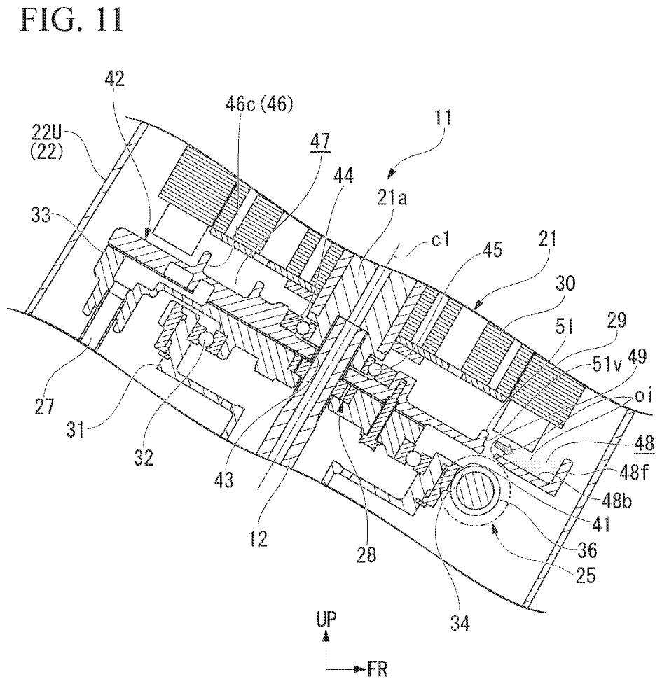

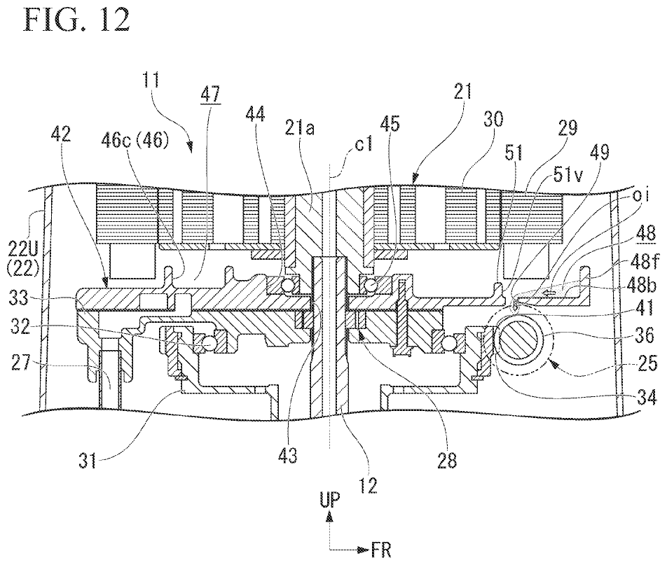

FIG. 11 is a cross-sectional view of part of the outboard motor 11 showing the flow of the oil oi when the outboard motor 11 is switched from the first disposition to the second disposition.

When the outboard motor 11 is switched from the state described above to the state (tilt-up state) of the second disposition as shown in FIG. 11, the oil oi stored in the oil preparation chamber 47 so far flows into the oil accumulation part 48 through the right and left straight sections 46s. In this way, the oil oi that flows into the oil accumulation part 48 is accumulated in a region surrounded by the bottom wall portion 48b, the front wall portion 48f, and the right and left side wall portions 48s of the oil accumulation part 48 as shown in FIG. 11.

Even when the outboard motor 11 is in the state (tilt-up state) of the second disposition for a long time, the oil oi continues to remain in the region described above of the oil accumulation part 48.

FIG. 12 is a cross-sectional view of part of the outboard motor 11 showing the flow of the oil oi when the outboard motor 11 is switched from the second disposition to the first disposition.

When the outboard motor 11 of the state (tilt-up state) of the second disposition is switched to the state of the first disposition when navigation of the marine vessel is restarted or the like, the bottom wall portion 48b of the oil accumulation part 48 becomes a horizontal disposition as shown in FIG. 12. Thereby, the oil oi in the oil accumulation part 48 flows downward through the discharge hole 49. The oil oi that has flowed downward from the discharge hole 49 drops onto the engagement portion 41 between the worm 36 and the outer tooth 34, lubricates the engagement portion 41, and then flows further downward. At this time, even when the electric motor 21 that drives the pump device 28 is in a stopped state, the engagement portion 41 between the worm 36 and the outer tooth 34 and other lubricated portions are promptly lubricated by the oil oi dropped from the discharge hole 49.

Accordingly, for example, even when steering is performed by the electric motor 25 while stopping the electric motor 21 for driving the screw after the outboard motor 11 is switched to the state of the first disposition, lubrication insufficiency of the lubricated portion of the apparatus of a steering system does not occur.

As described above, in the outboard motor 11 of the present embodiment, the oil guide member 42 includes the discharge hole 49 and the oil accumulation part 48. The discharge hole is arranged at a position that enables dropping of the oil to the lubricated portion in the state of the first disposition. The oil accumulation part 48 can accumulate the oil in the state of the second disposition and drain the accumulated oil to the discharge hole 49 in the state of the first disposition.

Accordingly, when the oil guide member 42 of the present embodiment is employed, it is possible to promptly supply oil to the lubricated portion of the apparatus even after the navigation of the marine vessel 1 is stopped for a long time.

Further, the oil guide member 42 of the present embodiment has a configuration in which the oil accumulation part 48 includes the bottom wall portion 48b, the front wall portion 48f, and the pair of side wall portions 48s. The bottom wall portion 48b is arranged at a further forward side than the discharge hole 49, the front wall portion 48f stands upward from the front end section of the bottom wall portion 48b, and the pair of side wall portions 48s close the right and left sides of the bottom wall portion 48b and the front wall portion 48f. Therefore, when the outboard motor is switched from the state of the first disposition to the state of the second disposition, the oil becomes accumulated in the region surrounded by the bottom wall portion 48b, the front wall portion 48f, and the pair of side wall portions 48s.

When the oil guide member 42 of the present configuration is employed, it becomes possible to easily adjust the amount of accumulated oil in the state of the second disposition by appropriately changing protrusion heights of the pair of side wall portions 48s and the front wall portion 48f. Accordingly, the oil guide member 42 can be easily made in accordance with the specifications of the outboard motor 11.

Further, in the oil guide member 42 of the present embodiment, the regulation wall 51 that regulates the flow of the oil that flows rearward beyond the discharge hole 49 is provided on the rear section of the bottom wall portion 48b. Therefore, when the outboard motor 11 is switched from the state of the second disposition to the state of the first disposition, the oil flows rearward from the region surrounded by the bottom wall portion 48b, the front wall portion 48f, and the pair of side wall portions 48s, and at this time, the flow to the rearward side of the oil beyond the discharge hole 49 is regulated by the regulation wall 51.

Accordingly, when the oil guide member 42 of the present embodiment is employed, the oil accumulated in the oil accumulation part 48 in the state of the second disposition can be efficiently dropped downward from the discharge hole 49 at the time of switching to the first disposition.

Further, in the oil guide member 42 of the present embodiment, the V-shaped guide portion 51v that is inclined rearward from both right and left sides toward the rear portion of the discharge hole 49 is provided on the regulation wall 51. Therefore, when the outboard motor 11 is switched from the state of the second disposition to the state of the first disposition, the oil that flows rearward from the region surrounded by the bottom wall portion 48b, the front wall portion 48f, and the pair of side wall portions 48s of the oil accumulation part 48 can be efficiently collected toward the discharge hole 49 by the V-shaped guide portion 51v of the regulation wall 51.

Accordingly, when the oil guide member 42 of the present embodiment is employed, the oil accumulated in the oil accumulation part 48 in the state of the second disposition can be further efficiently dropped downward from the discharge hole 49 at the time of switching to the first disposition. Further, even when the amount of accumulated oil in the oil accumulation part 48 becomes small, the oil at the inside can be dropped from the discharge hole 49 without waste.

Further, the oil guide member 42 of the present embodiment includes the oil preparation chamber 47 that is capable of storing the oil at the first disposition and is capable of draining the stored oil to the oil accumulation part 48 at the second disposition. Therefore, the oil is stored in the oil preparation chamber 47 when the outboard motor 11 is in the state of the first disposition, and then, when the outboard motor 11 is switched from the state of the first disposition to the state of the second disposition, the oil stored in the oil preparation chamber 47 can flow into the oil accumulation part 48.

Accordingly, when the oil guide member 42 of the present embodiment is employed, even when the outboard motor 11 is stopped for a long time while maintaining the state of the first disposition and is then switched to the state of the second disposition, the stored oil of the oil preparation chamber 47 can be reliably accumulated in the oil accumulation part 48.

Further, in the oil guide member 42 of the present embodiment, the inclination passage 52 in which a portion close to the oil accumulation part 48 is at a higher position than a portion close to the oil preparation chamber 47 in the state of the first disposition is provided between the oil preparation chamber 47 and the oil accumulation part 48. The inclination passage 52 allows the oil to flow out from the oil preparation chamber 47 to the oil accumulation part 48 in the state of the second disposition. Therefore, when the outboard motor 11 is in the state of the first disposition, the oil in the oil preparation chamber 47 is reliably stored in the oil preparation chamber 47 without completely flowing out from the oil preparation chamber 47. Accordingly, even when the outboard motor 11 is stopped for a long time while maintaining the state of the first disposition, it is possible to prevent the oil preparation chamber 47 from becoming empty.

On the other hand, when the outboard motor 11 becomes the state of the second disposition from the state of the first disposition, the oil accumulated in the oil preparation chamber 47 can flow into the oil accumulation part 48 through the inclination passage 52. Accordingly, at the time of switching from the state of the first disposition to the state of the second disposition, the oil in the oil accumulation part 48 can be reliably dropped to the lubricated portion through the discharge hole 49.

Further, in the oil guide member 42 of the present embodiment, part of the oil preparation chamber 47 is arranged below the electric motor 21 for driving the screw at a drop position of the oil that has cooled the electric motor 21. Therefore, when the present configuration is employed, the oil can be reliably stored in the oil preparation chamber 47 without providing a dedicated passage for introducing the oil to the oil preparation chamber 47.

In the present embodiment, part of the oil preparation chamber 47 is arranged at the drop position of the oil that has cooled the electric motor 21; however, the entire region of the oil preparation chamber 47 may be arranged at the drop position of the oil.

Further, as a means for supplying oil to the oil preparation chamber 47, a dedicated supply passage that connects the discharge portion of the pump device 28 to the oil preparation chamber 47 may be provided.

Further, in the oil guide member 42 of the present embodiment, the oil preparation chamber 47 is formed of the groove 46 having a U shape in plan view that is arranged outside the annular circumferential wall 44 and is arranged such that each end of the pair of straight sections 46s of the groove 46 having the U shape faces forward. The oil accumulation part 48 is arranged between front end regions of the pair of straight sections 46s. In this case, since the oil preparation chamber 47 is provided so as to surround the annular circumferential wall 44 that is a bearing support portion, the electric motor 21 and the oil guide member 42 can be arranged to be sufficiently close to each other. Accordingly, when the present configuration is employed, it is possible to reduce the size of the outboard motor.

Further, in the case of the configuration described above, the oil that has cooled the electric motor 21 is stored in the groove 46 having a U shape in plan view of the oil preparation chamber 47. Therefore, when the outboard motor 11 is switched from the state of the first disposition to the state of the second disposition, the oil flows forward while being divided to right and left sides along the groove 46 having the U shape in plan view and flows into the oil accumulation part 48 arranged between the end regions of the groove 46 having the U shape. Accordingly, when the present configuration is employed, the oil in the oil preparation chamber 47 can smoothly flow to the oil accumulation part 48 on the forward side along the groove having the U shape at the time of switching to the second disposition.

Further, in the case of the configuration described above, since the oil is divided to two directions and flows into the oil accumulation part 48 from the oil preparation chamber 47, overflow of the oil does not easily occur when the oil flows into the oil accumulation part 48. Accordingly, when the present configuration is employed, the oil can be efficiently supplied to the lubricated portion without waste at the time of switching of the outboard motor 11 from the state of the first disposition to the state of the second disposition.

Further, the outboard motor 11 of the present embodiment includes: the electric motor 21 (drive source) for driving the screw; and the pump device 28 that operates by the power of the electric motor 21 and supplies the oil to the upper portion of the oil guide member 42. The engagement portion 41 by the gear between the electric motor 21 for steering driving and the power transmission device (power transmission cylinder 31) is arranged at the drop position of the oil from the discharge hole 49 of the oil guide member 42. In the case of this outboard motor 11, in a situation where the electric motor 21 (drive source) for driving the screw stops and the pump device 28 does not operate, the oil supply to the engagement portion 41 by the pump device 28 cannot be performed.

However, since the outboard motor 11 of the present embodiment includes the oil guide member 42 having the configuration described above, it is possible to promptly supply oil to the engagement portion 41 when the outboard motor 11 is switched from the state of the second disposition to the state of the first disposition even in the state where the electric motor 21 (drive source) for driving the screw is stopped.

Accordingly, in the outboard motor 11 of the present embodiment, even when steering is performed while stopping the electric motor 21 for driving the screw immediately after the outboard motor 11 is switched to the state of the second disposition from the state of the first disposition, it is possible to reliably lubricate the engagement portion 41 (lubricated portion) of the apparatus of the steering system by the oil.

The present invention is not limited to the embodiments described above, and various design changes can be made without departing from the scope of the invention. For example, in the embodiments described above, the electric motor 21 is employed as a drive source that drives the screw 19; however, the drive source is not limited thereto. The drive source may be, for example, an internal combustion engine or a hybrid-type drive source that uses both an internal combustion engine and an electric motor.

Further, the oil accumulation part 48 is formed of the bottom wall portion 48b that is arranged at a further forward position than the discharge hole 49, the front wall portion 48f that stands upward from the front end section of the bottom wall portion 48b, and the pair of side wall portions 48s that close the right and left sides of the bottom wall portion 48b and the front wall portion 48f; however, the shape and the structure of the oil accumulation part 48 is not limited thereto. The oil accumulation part 48 may be, for example, a curved hollow portion that is formed at a further forward side than the discharge hole 49 or the like. The oil accumulation part 48 may be a structure that can accumulate oil when the outboard motor 11 is in the second disposition and can drain the accumulated oil to the discharge hole 49 when the second disposition is changed to the first disposition.

Further, in the embodiment described above, the oil preparation chamber 47 is constituted of the groove 46 having a substantially U shape; however, the shape of the oil preparation chamber 47 is not limited thereto. The oil preparation chamber may have any shape that can store oil when the outboard motor is in the first disposition. Further, the number of oil routes that allow oil to flow to the oil reservoir from the oil preparation chamber is not limited two. The number of oil routes that allow oil to flow to the oil reservoir from the oil preparation chamber may be one or equal to or more than three.

### DESCRIPTION OF REFERENCE NUMERALS

11 Outboard motor
21 Electric motor (drive source)
22L Lower pivot case (steering portion)
25 Electric motor (electric motor for steering driving)
31 Power transmission cylinder (power transmission device)
37 Speed reducer (power transmission device)
41 Engagement portion
42 Oil guide member
44 Annular circumferential wall (support portion)
45 Bearing
46 Groove
47 Oil preparation chamber
48 Oil accumulation part
48b Bottom wall portion
48f Front wall portion
48s Side wall portion
49 Discharge hole
51 Regulation wall
52 Inclination passage

What is claimed is:

1. An outboard motor oil guide member that is used for an outboard motor capable of switching a disposition between a first disposition that is a disposition of the outboard motor at a time of navigation of a marine vessel and a second disposition in which a rear side is lifted further upward than the first disposition and guides oil for lubrication to a lubricated portion, the outboard motor oil guide member comprising:
a discharge hole that is arranged at a position that enables dropping of the oil to the lubricated portion in a state of the first disposition; and
an oil accumulation part that enables accumulation of the oil in a state of the second disposition and is capable of draining the accumulated oil to the discharge hole in the state of the first disposition.

2. The outboard motor oil guide member according to claim 1,
wherein the oil accumulation part comprises:
a bottom wall portion that is arranged at a further forward side than the discharge hole;
a front wall portion that stands upward from a front end section of the bottom wall portion; and
a pair of side wall portions that close right and left sides of the front wall portion and the bottom wall portion.

3. The outboard motor oil guide member according to claim 2,
wherein a regulation wall that regulates a flow of the oil that flows rearward beyond the discharge hole is provided on a rear section of the bottom wall portion.

4. The outboard motor oil guide member according to claim 3,
wherein at least part of the regulation wall is formed in a V shape in plan view that is inclined rearward from both right and left sides toward a rear portion of the discharge hole.

5. The outboard motor oil guide member according to claim 1, further comprising:
an oil preparation chamber that is capable of storing the oil in the state of the first disposition and is capable of draining the stored oil to the oil accumulation part in the state of the second disposition.

6. The outboard motor oil guide member according to claim 5,
wherein an inclination passage in which a portion close to the oil accumulation part is at a higher position than a portion close to the oil preparation chamber in the state of the first disposition and that allows the oil to flow out from the oil preparation chamber to the oil accumulation part in the state of the second disposition is arranged between the oil preparation chamber and the oil accumulation part.

7. The outboard motor oil guide member according to claim 6,
wherein at least part of the oil preparation chamber is arranged below an electric motor for driving a screw at a drop position of the oil that has cooled the electric motor.

8. The outboard motor oil guide member according to claim 7, further comprising:
a support portion of a bearing that supports a rotation shaft of the electric motor,
wherein the oil preparation chamber is formed of a groove having a U shape in plan view that is arranged outside the support portion of the bearing and is arranged such that each of a pair of end portions of the groove having the U shape faces forward, and
the oil accumulation part is arranged between a pair of end regions of the groove having the U shape.

9. An outboard motor that is capable of switching a disposition between a first disposition that is a disposition at a time of navigation of a marine vessel and a second disposition in which a rear side is lifted further upward than the first disposition, the outboard motor comprising:
an apparatus that requires lubrication at a time of operation; and
an oil guide member that guides oil for lubrication to a lubricated portion of the apparatus,
wherein the oil guide member comprises:
a discharge hole that is arranged at a position that enables dropping of the oil to the lubricated portion in a state of the first disposition; and
an oil accumulation part that enables accumulation of the oil in a state of the second disposition and is capable of draining the accumulated oil to the discharge hole in the state of the first disposition.

10. The outboard motor according to claim 9, further comprising:
a drive source for driving a screw; and
a pump device that operates by receiving power of the drive source and supplies oil to an upper portion of the oil guide member,
wherein the apparatus that requires lubrication at the time of operation includes
an electric motor for steering driving, and
a power transmission device that transmits power of the electric motor to a steering portion, and
the lubricated portion is an engagement portion by a gear between the power transmission device and the electric motor.
